(19) United States
(12) Patent Application Publication
(10) Pub. No.: US 2006/0151919 A1
(43) Pub. Date: Jul. 13, 2006

(54) Method for treating fabrics and their use in vehicle equipment, in particular motor vehicle equipment

(75) Inventors: Dieter Renner, Kempen (DE); Georg Mueller, Hilden (DE)

Correspondence Address: FOLEY & LARDNER LLP, 777 EAST WISCONSIN AVENUE, SUITE 3800, MILWAUKEE, WI, 53202-5308, US

(73) Assignee: Johnson Controls Interiors GmbH & Co. KG, Grefrath (DE)

(21) Appl. No.: 10/540,949

(22) PCT Filed: Oct. 11, 2003
(86) PCT No.: PCT/EP03/11277

§ 371 Date: Jan. 24, 2006

(30) Foreign Application Priority Data
Dec. 24, 2002 (DE) 102 60 988.8

(51) Int. Cl. B29C 35/08

(52) U.S. Cl. 264/400; 428/43

(57) ABSTRACT

The invention relates to a method for creating a pre-weakened zone in a textile surface structure, in particular a fabric. According to the method, part of the textile material is removed by laser treatment in order to create a predetermined breaking point, for example to allow exit of an airbag. To achieve this, a line of interspaced performations along the pre-weakened zone preferably deviates from the respective distance between the threads. The invention also relates to a method for producing a trim element for a vehicle, in addition to textile surface structures and trim elements that are produced according to the inventive method.

### BACKGROUND

The invention relates to a method for producing a weakening zone in a textile surface structure, in particular in a fabric, by partial removal of the textile material by means of treatment with a laser, and a textile surface structure treated by this method. The invention also relates to a method for producing a textile-laminated trim part, provided with an airbag flap, for a vehicle, in particular for a motor vehicle, and a trim part produced by this method.

The patent specification EP 0 711 627 B1 discloses generic methods, textiles and trim parts for motor vehicles. According to the method disclosed there, before being applied to a supporting element, a covering layer is provided on the rear with a groove-like weakening zone by means of treatment with a laser and the associated removal of material in that region in which the supporting element is to be equipped with a flap for the deployment opening of an airbag. The covering layer and the supporting element are subsequently inserted into a mold and the interspace between these components is filled with a soft foam layer.

According to a particular embodiment, the covering layer can also consist of a textile material which, on the rear, is joined to a glass fiber reinforcing layer. The groove produced by the laser cutting in this case penetrates completely through the glass fiber reinforcing layer and partially through the textile layer.

In order to prevent the laser beam passing completely through the covering layer and cutting up the trim part along the edges of the flap, or the weakening zone becoming visible from the interior of the vehicle, the wall thickness in the region of the weakening zone is kept to a constant value by regulating the laser as a function of the thickness of the covering layer. In this case, the preferred cutting depth is about 20 to 80% of the thickness of the covering layer. However, this regulation, carried out as a function of a feedback signal from a sensor, for example an ultrasonic sensor, is complicated and, when applied to textile covering layers, leads to unsatisfactory results, since their wall thickness drops to a value of “zero” between the threads and, consequently, a constant residual cross section cannot be achieved.

The document DE 198 50 742 A1 includes a description of a fabric whose intended rupture point for the airbag emergence is produced by introducing a seam with a defined tearing force. The tearing strength of the seam is dimensioned such that it withstands normal use but tears open when the airbag is deployed.

Intended rupture points of this type are in principle visible. In vehicle seats, which are normally assembled from numerous textile segments by sewing and in which the pattern of the seams also has a decorative character, this does not represent a disadvantage. For flat, textile-laminated trim parts, on the other hand, this procedure is not possible for visual reasons and because of the thickening in the seam region.

### SUMMARY

The invention is based on the object of providing a reliable and simple method for producing intended rupture points which are substantially invisible in textile surface structures.

According to one embodiment of the invention, the object is achieved in that mutually spaced holes are introduced into the threads of the textile surface structure in a linear arrangement.

Along the weakening zone, the spacing d of the holes preferably differs from the spacing D of the threads in each case. This procedure ensures that a large number of successive laser treatments in the thread interspaces, for example between the warp and weft threads of a fabric, do not remain ineffective and locally effect inadequate weakening of the textile surface structure.

The spacing d of the holes is preferably chosen to be lower than the thread spacing and is in particular 0.6 to 0.75 times the spacing D of the threads. Since, in the case of a curved course of the intended rupture point, the local spacing D of the threads along the weakening zone varies even in the case of a regular fabric structure, it may be necessary to vary the spacing d between the holes over the length of the weakening zone. In the case of regular fabrics, this can be carried out by means of appropriate control of the laser robot but, in the case of irregular textiles, by means of continuous determination of the local thread spacing D, for example by means of an analysis of the textile structure using the transmitted light method.

Since the textile surface structures suitable for use in motor vehicles tend to have a relatively rough surface, the holes can at least partly be formed as perforations penetrating the thread completely and preferably introduced from the side facing away from the interior of the vehicle. The exit openings, which are small in relation to the thread thicknesses normally used, are invisible, at least in the case of dark-colored textiles. In this case, it is possible to dispense with complicated regulation of the perforation depth.

Reliable introduction of the weakening zone may be brought about by the holes being introduced at an angle with respect to the surface of the textile surface structure. The inclination with respect to the local perpendicular to the surface of the textile surface structure is preferably 20° to 45°, in particular about 30°. The adjustment of the inclination can in this case be carried out, for example, by skewing the laser, by appropriate deflection of the laser beam by a mirror or by means of suitable positioning of the textile surface structure.

By using the method, a textile-laminated trim part, provided with an airbag flap, for a vehicle can preferably be produced by a weakening zone being introduced into a textile surface structure by a laser and said textile surface structure subsequently being applied to a supporting element, in particular laminated on. If, in order to improve the feel of the trim part, an intermediate layer of a soft foam is to be provided, the textile surface structure is advantageously provided with a soft foam on its side subsequently facing the supporting element, a linear weakening zone is introduced into the soft foam by means of a laser in a first step and, in a second step, the substantially congruent linear weakening zone is introduced into the textile surface structure.

On the supporting element side, the flap for the passage of the airbag can be produced in that, before or after the application of the textile surface structure, the supporting element is provided with a weakening zone which is arranged substantially congruently with the weakening zone in the textile surface structure. The weakening zone in the supporting element is preferably produced by local material removal by a laser.

### BRIEF DESCRIPTION OF THE FIGURES

The figures illustrate exemplary and schematically different embodiments of the invention.

FIG. 1 shows a textile-laminated trim part designed according to the invention and having an airbag exit flap

FIG. 2 shows a section A-A through the trim part according to FIG. 1

FIG. 3 shows an enlarged section B-B through the weakening zone of the airbag exit flap in the trim part according to FIG. 1

FIG. 4 shows an illustration of the arrangement of the holes in the textile surface structure according to a first embodiment of the invention

FIG. 5 shows the arrangement of the holes according to another embodiment of the invention

### DETAILED DESCRIPTION

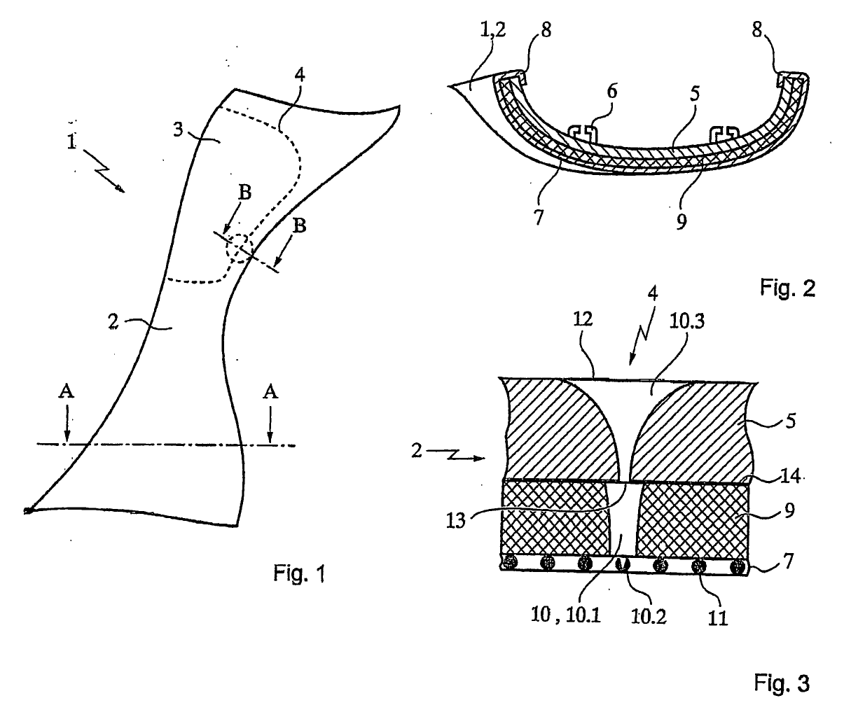

The trim part 1 depicted in FIG. 1 is designed as a pillar trim 2 for covering the C pillar of a passenger car, which is equipped with a side airbag, not illustrated, in order to protect the rear occupants. Said airbag is arranged between the upper region of the pillar trim 2 and the vehicle body and, in the event of an accident, is deployed toward the interior of the vehicle through an airbag exit flap 3. The airbag exit flap is integrated into the pillar trim 2 so as to be invisible to the occupants and, after tearing open a linear, U-shaped weakening zone 4 (intended rupture point) introduced into said trim, pivots toward the interior, as a result of which an exit opening for the airbag being deployed is formed in the trim part 1.

As FIG. 2 reveals, the pillar trim 2 comprises a curved supporting element 5 having fixing elements 6, by means of which it can be latched to the C pillar of the vehicle body. The supporting element is preferably fabricated by means of injection molding from a rigid plastic which can be processed thermoplastically, for example polypropylene.

On the interior side, the pillar trim 2 is lined with a textile surface structure 7 in the form of a polyester or polyester-wool mixed fabric, which is drawn laterally around the supporting element 5, forming a bent over part 8. Arranged between the supporting element 5 and textile surface structure 7 in order to improve the feel is a soft foam layer 9 of 3 to 5 mm thickness, which preferably consists of a closed-cell polyester or polyurethane foam.

In the region of the weakening zone 4, the pillar trim 2 is provided with a large number of linearly arranged, mutually spaced holes 10, whose formation emerges from FIG. 3. In a first operation, the textile surface structure 7 and the soft foam layer 9 are joined to each other, for example by means of flame lamination. Then, by material removal through use of a laser, holes 10.1 are introduced into the soft foam layer 9 at a high advance speed. Because of the low thickness of the soft foam layer 9, the time required for material removal is very low, in addition holes 10.1 with a relatively large diameter are necessarily formed, merge into one another and can thus form a groove-like weakening zone 4. The composite comprising soft foam layer 9 and textile surface structure 7 is then again subjected to a laser treatment at a lower advance speed in the region of the weakening zone 4, which results in the formation of smaller holes 10.2 in the threads 11 (warp and/or weft threads).

Separately from this, the weakening zone 4 is also formed in the supporting element 5 by lining up laser-generated holes 10.3 in a row, the entry zone 12 of the laser having a wider material removal than the exit zone 13 facing the interior of the vehicle. The same is true of the holes 10.1 and 10.2, the differences in diameter in the soft foam layer 9 turning out smaller than in the supporting element 5 and in the threads 11.

The composite comprising the soft foam layer 9 and textile surface structure 7 is then laminated onto the surface of the supporting element 5 on the side of the interior by adding an adhesive 14, in such a way that the linearly arranged holes 10.1 to 10.3 in the region of the weakening zone 4 substantially coincide.

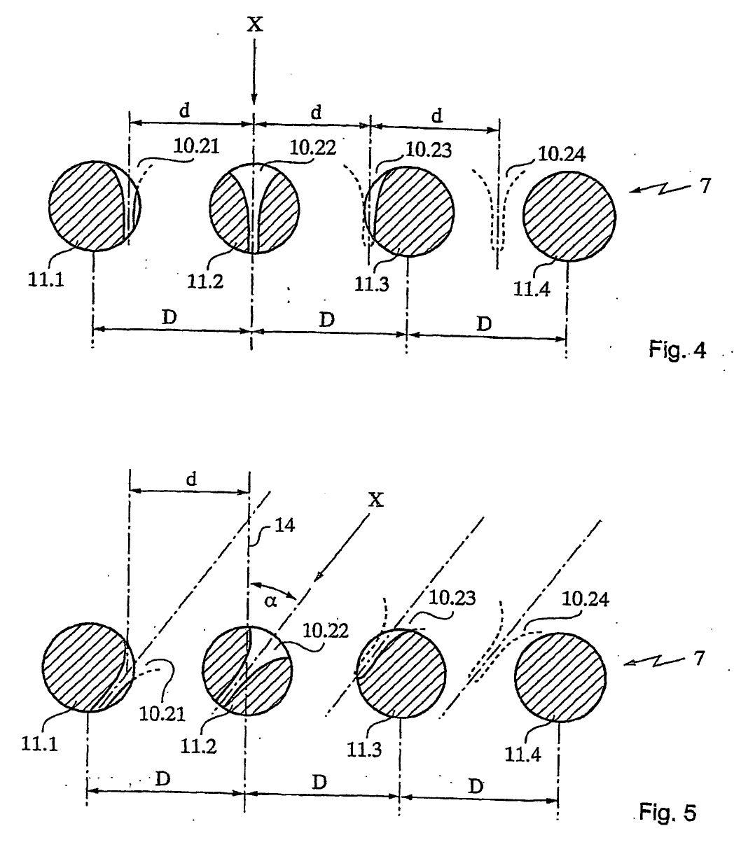

FIG. 4 shows, in a first example, the arrangement of the holes 10.2 in the textile surface structure 7. The threads 11.1 to 11.4, whose spacing D from thread center to thread center can be 350 μm, for example, are treated from their side facing away from the interior of the vehicle with a laser (arrow X), which causes the crater-like material removal already mentioned. In this illustration, the laser strikes the thread 11.2 centrally at right angles to the surface of the textile surface structure 7 and produces a central, continuous hole 10.22. The exit opening has a very small diameter and is barely detectable from the interior of the vehicle with the naked eye.

The axes of the holes 10.21 to 10.24 are offset from one another by a spacing d which is smaller than the spacing D between the threads 11 and, in the exemplary embodiment, is about 250 μm. Because of this difference in spacing, although the threads 11.1 and 11.3 adjacent to the thread 11.2 are only partly caught by the laser, and the thread 11.4 adjacent thereto is not caught by the laser at all, so that the (imaginary) hole 10.24 runs into empty space, it is possible to reliably avoid all the holes 10.2 running between the threads 11 and thus no weakening zone being formed.

Given the same laser intensity and therefore an unchanging exit diameter, the material removal in the weakening zone 4 may be increased in that, with an unchanged spacing d of the holes 10.2, the laser beam strikes the surface of the. textile surface structure 7 which is inclined at an angle a with respect to the perpendicular 14 to the latter. In the exemplary embodiment, the best results can be achieved with inclinations of 20° to 45°, in particular about 30°.

The textile surface structure 7 is usually treated with the laser in a flat alignment and then applied to a complexly shaped supporting element 5. In exceptional cases, however, the laser treatment of an already three-dimensionally deformed textile surface structure 7 may also become necessary, so that the alignment of the laser (arrow X) with respect to the local surface of the textile surface structure 7 has to be readjusted when moving along the linear weakening zone 4.

Of course, textiles treated in this way are not just suitable for the lamination of flat trim parts but can also be used in other equipment, for example vehicle seats with integrated airbag. Likewise, use in the clothing industry, for example in the production of safety clothing (workwear, protective clothing with integrated airbag for motorcyclists) is conceivable.

1.-16. (canceled)

17. A method for producing a weakening zone on a component for deployment of an airbag device, the method comprising:
providing a textile surface structure for the component;
introducing a plurality of holes into threads of the textile surface structure to define the weakening zone.

18. The method of claim 17 wherein the step of introducing the plurality of holes comprises partially removing textile material with a laser.

19. The method of claim 17 wherein the holes in the threads of the textile surface structure include an entry opening having a first dimension and an exit opening having a second dimension smaller than the first dimension.

20. The method of claim 17 wherein the textile is a fabric.

21. The method of claim 17 wherein the spacing of the holes in the texture surface structure differs from the spacing of the threads.

22. The method of claim 21 wherein spacing between the holes is 0.6 to 0.75 times the spacing between the threads.

23. The method of claim 17 wherein the holes are at least partly formed as perforations disposed in a linear arrangement.

24. The method of claim 17 wherein the holes are introduced at an angle with respect to the surface of the textile surface structure.

25. The method of claim 24 wherein the angle is between about 20 degrees and 45 degrees.

26. The method of claim 25 wherein the angle is about 30 degrees.

27. The method of claim 17 wherein the component is a vehicle interior component.

28. The method of claim 27 wherein the vehicle interior component is for a vehicle seat.

29. The method of claim 17 wherein the component is for an item of clothing such as safety workwear or protective clothing with an integrated airbag for motorcyclists.

30. A method for producing a vehicle component having an airbag exit flap, the method comprising:
providing a foam layer and a textile surface structure;
introducing a plurality of holes into the foam layer by applying a laser treatment;
introducing a plurality of holes into threads of the textile surface structure by applying a laser treatment.

31. The method of claim 30 wherein introducing the plurality of holes into the foam layer occurs before introducing the plurality of holes into threads of the textile surface structure.

32. The method of claim 30 further comprising providing a supporting element and joining the foam layer and the textile surface structure to the supporting element.

33. The method of claim 32 further comprising introducing a weakening zone to the supporting element before joining the foam layer and the textile surface structure to the supporting element.

34. The method of claim 32 further comprising introducing a weakening zone to the supporting element after joining the foam layer and the textile surface structure to the supporting element.

35. A method for producing vehicle trim component having an airbag exit flap, the method comprising:
providing a foam layer, a textile surface structure, and a supporting element;
introducing a plurality of holes to the supporting element;
joining the foam layer to the textile surface structure;
introducing a plurality of holes to the foam layer by applying a laser treatment, then;
introducing a plurality of holes to threads of the textile surface structure by applying a laser treatment;
laminating the foam layer and the textile surface structure to the supporting element so that the holes in the foam layer, textile surface structure, and supporting element substantially coincide.

36. The method of claim 35 further comprising introducing a weakening zone to the supporting element before joining the foam layer and the textile surface structure to the supporting element.

37. The method of claim 35 further comprising introducing a weakening zone to the supporting element after joining the foam layer and the textile surface structure to the supporting element.

38. The method of claim 35 wherein the weakening zone in the supporting element is produced by local material removal by a laser.
